(19) United States
(12) Patent Application Publication
(10) Pub. No.: US 2023/0334999 A1
(43) Pub. Date: Oct. 19, 2023

(54) CLOUD-BASED AI-POWERED ENTREPRENEURSHIP TRAINING SYSTEM AND METHOD

(71) Applicant: Sai SatyaDeep Kotla, Pleasanton, CA (US)

(72) Inventor: Sai SatyaDeep Kotla, Pleasanton, CA (US)

(21) Appl. No.: 17/723,602

(22) Filed: Apr. 19, 2022

(51) Int. Cl. G09B 5/06; G09B 21/00

(52) U.S. Cl. CPC G09B 5/065; G09B 21/009; G09B 21/003

(57) ABSTRACT

A system for providing artificial intelligence (AI) powered entrepreneurship training is disclosed. The system comprises a computing device having a processor and a non-transitory memory unit configured to store a set of instructions executable by the processor during each step of training, a database to store a plurality of data related to real-world business portfolio, and a user device to establish interaction between the users during entrepreneurship training. The system further includes a learning-based application platform configured to learn entrepreneurship skills and strengthen communication, and one or more Li-Fi-based devices or sensors connected to an AI-powered cloud assistive system connected to the learning-based application platform to assist users. The system reimages digital information to a tactile surface to assist the visually blind, hearing/speech impaired to touch and perceive the information. Further, the system interchanges transcription/translation modes as per user requirements and provides authentic learning and real-world business access simultaneously.

### FIELD OF THE INVENTION

The present invention generally relates to a learning platform. More specifically, the present invention relates to a system and method for entrepreneurship training using a cloud-based AI-powered assistive technology.

### BACKGROUND

The learning platforms are portals or web spaces that provide educational content and information related to specific topics. These are online services provided to learners and administrators with tools and resources to help enhance their learning. These learning platforms are improving day by day with technological advances. There are various learning platforms to support learners worldwide. One among them is the entrepreneurship skill learning platform. These platforms provide real-world business-related content, and information and train learners to develop entrepreneurship skills.

There exist various systems and methods for cloud-based entrepreneurship training Few existing patent references attempted to address the problems cited in the background as prior art over the presently disclosed subject matter and are explained as follows:

A prior art U.S. Ser. No. 11/170,782 B2 assigned to Cameron stoker et.al., entitled “Real-time audio transcription, video conferencing, and online collaboration system and methods” discloses a real-time audio transcription, video conferencing, and online collaboration system includes a microphone that records audio from a lecturer, a camera that captures video from the lecturer and/or users, and a user interface for viewing a transcription of the audio. The audio recording is transmitted to a storage device, such as a personal computer or mobile device, which transmits the audio to a voice-to-text application for transcription. The storage device may do so via a third-party cloud server, a web application, or a software application. The transcribed text is then transmitted to a user interface for viewing by hearing-impaired persons. The transcribed text is provided in real-time with the lecturer and audio-recording and presented word-for-word to the user during transcription and may be edited in real-time to improve accuracy of the automatic transcription.

Another prior art U.S. Ser. No. 10/176,366 B1 assigned to Conrad A. Maxwell, entitled “Video relay service, communication system, and related methods for performing artificial intelligence sign language translation services in a video relay service environment” discloses a video relay service for providing automatic translation services during a real-time communication session. The video relay service comprises at least one server configured to receive a video stream containing sign language content from a video communication device associated with a hearing-impaired user; automatically translate the sign language content into a verbal language translation during the real-time communication session without assistance of a human sign language interpreter, and transmit the verbal language translation to a far-end communication device associated with a hearing-capable user during the real-time communication session.

Another prior art IN 201721028277 A assigned to Shendumikar, et.al., entitled “System & apparatus to economically monitor quality & delivery of “emotional education” discloses a hardware and software application for secured distribution of multi-media content comprising explicitly of emotional education from a central location to geographically spread distant, multiple remote centers. The objective is to procure the copyrighted two or more-dimensional, censor-certified, demonstrative, interactive content in text-audio-video-animated format and in a plurality of languages which is inclusive of brail. A real-time duplex interaction with a centralized domain expert through satellite-based secured data exchange is provided. The self-contained cloud-based AI-driven algorithm depicts per user, real-time consumption pattern of the aforesaid contents that has society alignment and is expected to have immense impact in creating business opportunities with SMART technocrats and entrepreneurs within the country. Smooth control of operations is done via artificial intelligence-driven, cloud-based enabled Web-oriented & Mobile based software & inventor's Application. As it is interactive with multiple locations, students can interact with the super experts, on one-to-one basis, which will be a life-changing and lifetime opportunity for students.

Another prior art U.S. Ser. No. 11/062,616 B2 assigned to Srirupa Chakraborty, et.al., entitled “Interactive learning experience” discloses a system, program product, and method for use with an intelligent (AI) computer platform to explore real-world modeling. A sensory input data signal is communicated to the AI platform and translated into a corresponding scenario. The translation is directed at an associated force and application of the force to a selected or identified object and environment. A reaction to the application is created, and reaction data is converted to a sensory output signal. Receipt of the sensory output signal by a corresponding sensory output device creates a physical manifestation of generated feedback of the reaction data to a sensory medium. The embodiments are directed at both learning and assessment and leverage a corpus with the AI platform in support of an interactive learning experience.

Though the above prior art discloses various systems and methods for the interactive learning platform, none of them discloses a platform that includes the real-world activity of a particular line of business that transcription and/or translations the pre-defined (bespoke) business activities and commands. Further, the system uses a Li-Fi or sensor to reflect the information on an Android/iOS device onto a touchpad only for our business, and educational content is not disclosed. Also, a system that reflects an exact image of a learning platform with tactile bubbles is nowhere disclosed.

Therefore, there is a need for a system and method for entrepreneurship training using a cloud-based AI-powered assistive technology. Also, there is a need for a system that provides a learning-based application platform to learn entrepreneurship skills and strengthen communication. Further, there is a need for a system that uses Li-Fi or a sensor to reflect the information to a touchpad. And also, there is a need for a system that reflects an exact image of the learning platform with tactile bubbles.

### SUMMARY OF THE INVENTION

The present invention generally discloses a business skill learning platform. Also, the present invention discloses a system and method for entrepreneurship training using a cloud-based AI-powered assistive technology.

According to the present invention, a computer-implemented system is executed in a network environment for providing artificial intelligence (AI) powered entrepreneurship training. In one embodiment of the present invention. The system runs in a computer-implemented environment configured to provide authentic learning in real-world business. In one embodiment, the system is an AI-based entrepreneurship schooling system for acquiring skills and knowledge related to business information. In one embodiment, the system provides a learning-based application platform to learn entrepreneurship skills and strengthen communication. In one embodiment, the system is a cloud-based AI-powered and Li-Fi-based assistive technology solution. Further, the system assists communities with barriers in perceiving and responding to business information and in learning job skills and knowledge related to them. Also, the system reimages digital images to assist the visually blind, hearing/speech impaired to touch and perceive the information.

In one embodiment, the system is an application software or mobile application, or, a web-based application. In one embodiment, the application is executed in a computer-implemented environment or network environment. In one embodiment, the computer-implemented environment comprises user devices, a computing device, and a portfolio management system. Each user device is associated with a user. In one embodiment, the user device is installed with a learning-based application platform. In one embodiment, the application platform trains users with business information using a cloud-based AI-powered assistive technology (i.e., PRAGNYA). The user device is enabled to access the portfolio management system via a communication network. The user device has a user interface. In one embodiment, the user device is at least any one of a smartphone, a mobile phone, a laptop, a computer, a desktop, a tablet, or other suitable mobile and/or handheld electronic communication devices. In one embodiment, the user device comprises a storage medium in communication with the network to access the portfolio management system configured to train the users with business-related skills and jobs. In an embodiment, the network may be a Wi-Fi network, a WiMAX network, a local area network (LAN), a wide area network (WAN), and a wireless local area network (WLAN).

In one embodiment, the portfolio management system comprises a server or computing device and one or more databases in communication with the computing device. In one embodiment, the computing device may be a cloud server. In one embodiment, the database is in communication with the computing device via the network. In one embodiment, the database is accessible by the server. In one embodiment, the computing device comprises a processor and computer-readable medium or memory unit coupled to the processor. The memory unit stores a set of instructions executable by the processor during each step of training.

In one embodiment, the computing device is configured to reimage the digital information using light waves or electric or electromagnetic, or sound waves onto a tactile surface to assist the visually blind, hearing/speech impaired to touch and perceive the information. In one embodiment, further the computing device is configured to interchange transcription/translation modes as per user requirements. In one embodiment, further the computing device is configured to provide authentic learning and real-world business access simultaneously, thereby providing a cross-continental business sustainability model through AI-powered assistive system.

In one embodiment, the system further includes one or more Li-Fi-based devices or sensors connected to the AI-powered cloud assistive system having a cloud-based based solution connected to the learning-based application platform to assist users. In one embodiment, the Li-Fi transcribes the digital content onto SPARSA (tactile pad) so that visually blind, hearing/speech impaired people can touch and perceive the information on SPARSA. In one embodiment, SPARSA is a tactile pad that maintains tactile information from PRAGNYA.

In one embodiment, the AI-powered assistive system is configured to transcribe information from a format including visual, audio, textual, or tactile modes to another format. In one embodiment, the AI-powered assistive system is configured to transcribe digital information onto a tactile pad to assist users including the visually blind, and hearing/speech impaired to touch and perceive the information by reimaging the digital information. In one embodiment, the AI-powered assistive system is further configured to translate relayed digital information from a language to the user's desired language, including sign languages. In one embodiment, further the AI-powered assistive system is configured to interchange modes between audio to video/sign language based on the user's requirement. In one embodiment, further the AI-powered assistive system provides runtime or offline mode of operations. In one embodiment, the system has remote access as the information is relayed cloud-based. Further, the system has exclusive access as only the destined user can operate PRAGNYA. The system also uses the face/voice/thumb recognition of the user.

In one embodiment, a method for providing artificial intelligence (AI) based entrepreneurship training is disclosed. In one embodiment, the method includes the following steps. At one step, the system provides a cross-continental business sustainability model through an AI-powered assistive system. In one embodiment, the AI-powered cloud assistive system includes a cloud-based based solution connected to one or more Li-Fi-based devices or sensors and connected to a learning-based application platform to assist users. In one embodiment, the AI-powered assistive system comprises the following steps. At another step, the system provides entrepreneurship training specific to the business portfolio in simulation mode. At another step, the system presents a regional and global portfolio via an earning module in entrepreneurship mode to acquire knowledge related to business information. At another step, the system provides an authentication-based training curriculum/authentic learning and real-world business access simultaneously for context, resources, tools, tasks, and time period for users and admins.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a computer-implemented system executed in a network environment for providing artificial intelligence (AI) powered entrepreneurship training in an embodiment of the present invention.

FIG. 2 shows a screenshot of a learning platform for providing entrepreneurship training in one embodiment of the present invention.

FIG. 3 shows a screenshot of a business model in one embodiment of the present invention.

FIG. 4 shows a screenshot of an authenticated method training curriculum in an embodiment of the present invention.

FIG. 5 shows a screenshot of a social mission in an embodiment of the present invention.

FIG. 6 shows a method flow for providing artificial intelligence (AI) based entrepreneurship training in an embodiment of the present invention.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

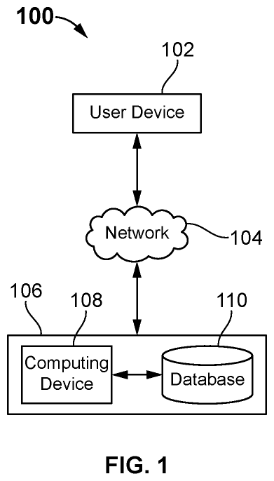

Referring to FIG. 1, a computer-implemented system executed in a network environment 100 for providing artificial intelligence (AI) powered entrepreneurship training, according to one embodiment of the present invention. The system runs in the computer-implemented environment 100 configured to provide authentic learning in real-world business. In one embodiment, the system is an AI-based entrepreneurship schooling system for acquiring skills and knowledge related to business information. In one embodiment, the system provides a learning-based application platform to learn entrepreneurship skills and strengthen communication. In one embodiment, the system is a cloud-based AI-powered and Li-Fi-based assistive technology solution. Further, the system assists communities with barriers in perceiving and responding to business information and in learning job skills and knowledge related to them. Also, the system reimages digital images to assist the visually blind, hearing/speech impaired to touch and perceive the information.

In one embodiment, the network environment 100 comprises one or more user devices 102. Each user device 102 is associated with a user. In one embodiment, the user device 102 is installed with a learning-based application platform. In one embodiment, the application platform trains users with business information using a cloud-based AI-powered assistive technology (i.e., PRAGNYA). In one embodiment, the application platform may be an application software or mobile application or web-based application, or software application. In one embodiment, the user device 102 includes a user interface with a user profile associated with each user configured to establish interaction between the users during entrepreneurship training. The system further comprises a network 104 and a portfolio management system 106. In one embodiment, the user device 102 is enabled to access the portfolio management system 106 via the network 104. In one embodiment, the user device 102 enables the user to access one or more services provided by the system. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the portfolio management system 106. In an embodiment, the network 104 could be Wi-Fi, WiMAX, wireless local area network (WLAN), satellite networks, cellular networks, private networks, and the like.

In one embodiment, the portfolio management system 106 comprises a computing device 108 and one or more databases 110 in communication with the computing device 108. In one embodiment, the computing device 108 is a server. In one embodiment, the computing device 108 could be a cloud server. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of application software, a mobile application, a browser, an OS, and/or any combination thereof.

In one embodiment, the database 110 is in communication with the computing device 108 via the network 104. In one embodiment, the database 110 is accessible by the computing device 108. In another embodiment, the database 110 is integrated into the computing device 108 or separate from it. In some embodiments, the database 110 resides in a connected server or a cloud computing service. Regardless of location, the database 110 comprises a memory to store and organize certain data for use by the computing device 108. In one embodiment, the database 110 is configured to store a plurality of data related to the real-world business portfolio.

In one embodiment, the computing device 108 comprises a processor and a computer-readable medium or memory unit coupled to the processor. The memory unit stores a set of instructions executable by the processor during each step of training. The memory unit could be RAM, and ROM (including EPROM, EEPROM, PROM). In one embodiment, the user devices 102 are configured to access the services provided by the computing device 108 via the network 104.

In one embodiment, the computing device 108 is configured to reimage the digital information using light waves or electric or electromagnetic, or sound waves onto a tactile surface to assist visually blind, hearing/speech impaired to touch and perceive the information. In one embodiment, further the computing device 108 is configured to interchange transcription/translation modes as per user requirement. In one embodiment, further the computing device 108 is configured to provide authentic learning and real-world business access simultaneously, thereby providing a cross-continental business sustainability model through AI-powered assistive system.

In one embodiment, the system further includes one or more Li-Fi-based devices or sensors connected to the AI-powered cloud assistive system having a cloud-based based solution connected to the learning-based application platform to assist users. In one embodiment, the Li-Fi transcribes the digital content onto SPARSA (tactile pad) so that visually blind, hearing/speech impaired people can touch and perceive the information on SPARSA. In one embodiment, SPARSA is a tactile pad that maintains tactile information from PRAGNYA.

In one embodiment, the AI-powered assistive system is configured to transcribe information from a format including visual, audio, textual, or tactile modes to another format. In one embodiment, the AI-powered assistive system is configured to transcribe digital information onto a tactile pad to assist users including the visually blind, and hearing/speech impaired to touch and perceive the information by reimaging of the digital information. In one embodiment, the AI-powered assistive system is further configured to translate relayed digital information from a language to the user's desired language, including sign languages. In one embodiment, further the AI-powered assistive system is configured to interchange modes between audio to video/sign language based on the user's requirement. In one embodiment, further the AI-powered assistive system provides runtime or offline mode of operations. In one embodiment, the system has remote access as the information is relayed cloud-based. Further, the system has exclusive access as only the destined user can operate PRAGNYA. The system also uses the face/voice/thumb recognition of the user.

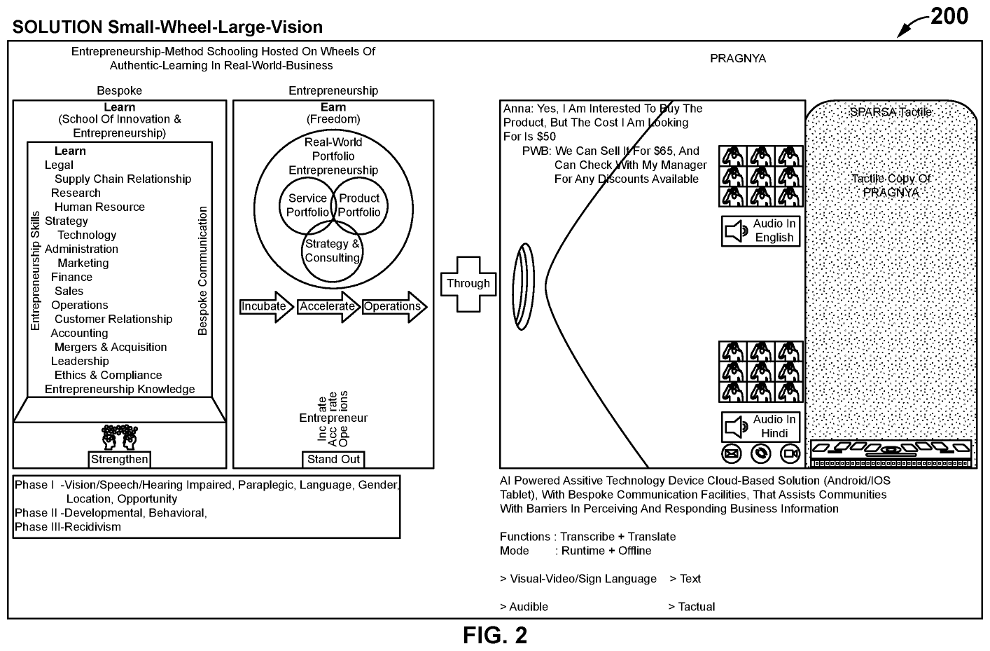

Referring to FIG. 2, a screenshot of a learning platform 200 for providing entrepreneurship training, according to one embodiment of the present invention. In one embodiment, the learning platform 200 shows the learning-based application for entrepreneurship method schooling hosted on wheels of authentic learning in real-world business (i.e., small wheel large vision) via PRAGNYA. In one embodiment, the system includes a Bespoke module for Learning (i.e., school of innovation and entrepreneurship) and an Entrepreneurship module for earning (i.e., freedom). In one embodiment, the learning-based application platform provides communication facilities (bespoke) to assist users with barriers, including, physical, sensory, intellectual, behavioral, language, knowledge, academic, location, discrimination, gender, accessibility to opportunity, recidivism, job skills, culture, underprivileged, under pre-presented and the like. In one embodiment, the learning-based application further perceives and responds to the business information and learns job skills and knowledge related to the business environment provided in the learning-based application platform. In one embodiment, the learning-based application platform enables users to learn business strategies, such as legal, supply chain research, human resource strategy, technology administration, marketing, finance, sales, operations, consumer relationships, accounts, mergers and acquisition, leadership, ethics and compliance, and entrepreneurship knowledge.

In one embodiment, the entrepreneurship module provides real-world portfolio entrepreneurship to access real-world business experience for users by providing, a service portfolio, product portfolio, and service and consulting (as shown in FIG. 2). In one embodiment, the module performs incubate, accelerate, and operations. In one embodiment, the further the system functions in three phases. In phase I, the vision/speech/hearing impaired, paraplegic, language, gender, location, and opportunity are verified. In phase II, Developmental, Behavioral functions are processed, and in phase 3 Recidivism is done. In one embodiment, the affordable & accessible assistive technology along with the entrepreneurship method schooling provides both authentic learning (in simulation mode) and also real-world business access at the same time. In one embodiment, the learning and application of the learning happen hand-in-hand to strengthen communities with barriers to gaining entrepreneur skills, and stands-out as independent business leaders who own and operate their respective business portfolios while accessing global business opportunities.

In one embodiment, the learning-based application i.e., PRAGNYA assists communities with the barrier to perceiving and responding to business information. For example, the system shows a message from Anna “I am interested to buy the product, but the cost I'm looking for is 50”. And a message from PWD shows as “we can sell it for $65, and can check with my manager for any discounts available”. In one embodiment, the platform now converts the audio in English to audio in Hindi. In one embodiment, the system stores a tactical copy of PRAGNYA (i.e., SPARSA tactical) to assist users who are visually blind, hearing/speech impaired to touch and perceive the information by reimaging the digital information. In one embodiment, further the platform has messaging, calling, and video calling facilities. In one embodiment, the platform functions as transcription and translation. In one embodiment, the platform performs in runtime mode and offline mode. Further, the system converts the visual-video/sign language or spoken language into text. Similarly, the system converts the audible tone into tactual.

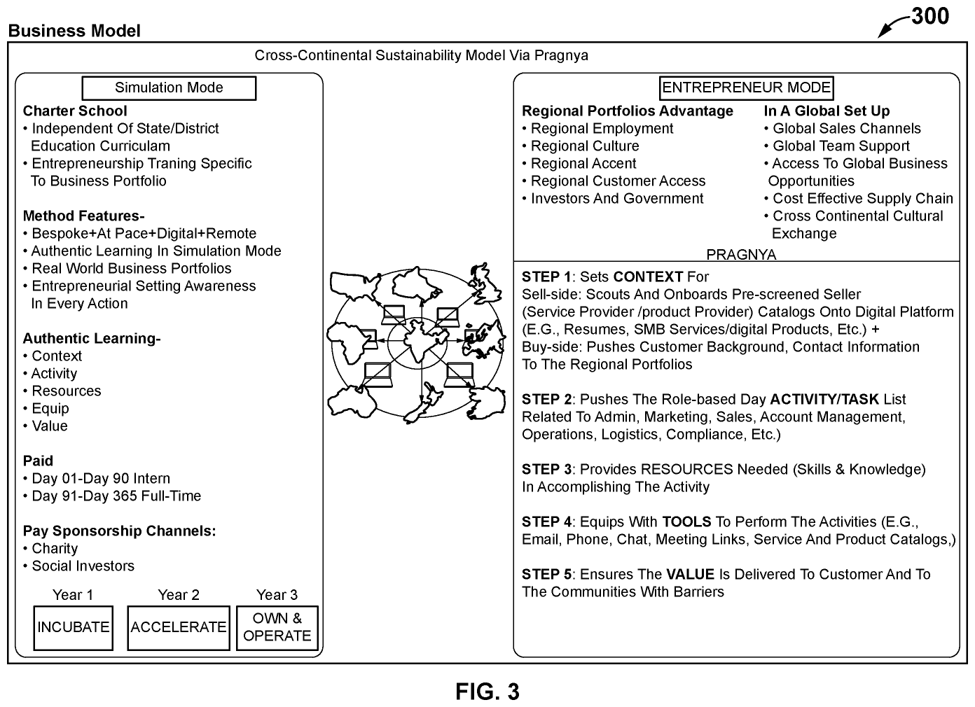

Referring to FIG. 3, a screenshot of a business model 300, according to one embodiment of the present invention. In one embodiment, the business model 300 shows a cross-continental sustainability model via PRAGNYA. In one embodiment, the business model 300 comprises simulation mode and entrepreneur mode. In one embodiment, the simulation mode provides entrepreneurship training specific to business portfolios through a learning module. In one embodiment, the simulation mode includes a charter school. In one embodiment, the charter school is independent of state/district educational curriculum and entrepreneurship training specific to the business portfolio. In one embodiment, the system further includes method features such as bespoke at pace in digital and remote, authentic learning in the simulation model, real-world business portfolio, and entrepreneurial setting awareness in every action. In one embodiment, further the authentic learning includes steps of context, activity, resources, equip, and value (i.e., teachings of authentic learning). In one embodiment, further the users are paid from Day01-Day 90 as interns and Day 91-Day 365 as full time. In one embodiment, further the system includes the pay sponsorship channels like charity and social investors. These are classified as incubated at year 1, accelerate at year 2, and own and operate at year 3.

In one embodiment, the earning module presents a regional and global portfolio in entrepreneurship mode to acquire knowledge related to business information. In one embodiment, the entrepreneur mode includes the following regional portfolio advantages such as regional employment, regional culture, regional accent, regional customer access, and investors and government. In one embodiment, further the entrepreneur mode in a global setup has global sales channels, global team support, access to global business opportunities, a cost-effective supply chain, and cross-continental cultural exchange. In one embodiment, the learning-based application platform i.e., PRAGNYA includes the following steps. At step 1, the system sets a context for the sell-side and buy-side. In one embodiment, the set-side includes scout and onboards pre-screened seller (e.g., service provider/product provider) catalogs onto the digital platform (e.g., resumes, smb services/digital products, etc.). In one embodiment, the buy-side pushes customer background, and contact information to the regional portfolios. At step 2, the system pushes the role-based day activity/task list related to admin, marketing, sales, account management, operations, logistics, compliance, etc. At step 3, the system provides the resources needed (e.g., skills & knowledge) in accomplishing the activity. At step 4, the system equips with tools to perform the activities such as email, phone, chat, meeting links, service, and product catalogs. At step 5, the system ensures the value is delivered to the customer and the communities with barriers.

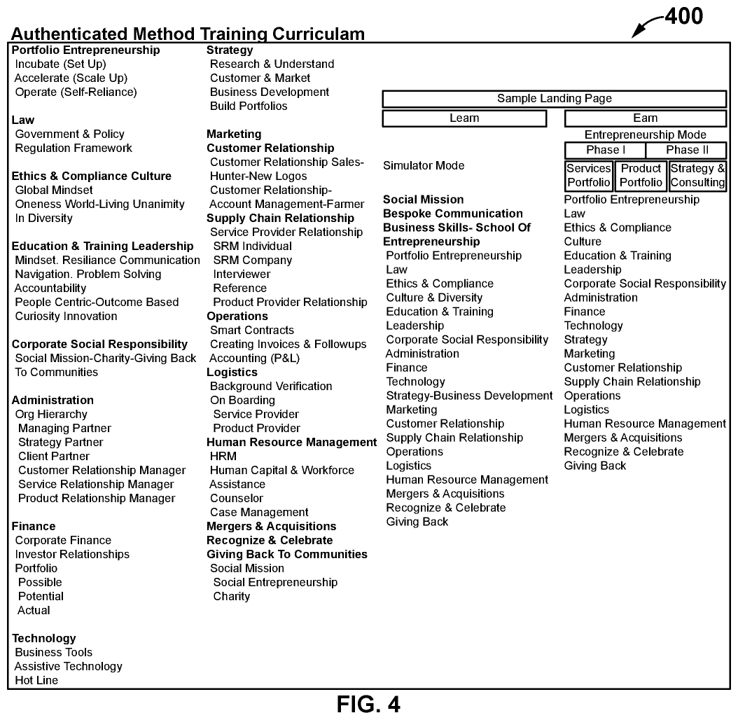

Referring to FIG. 4, a screenshot 400 of an authenticated method training curriculum, according to one embodiment of the present invention. In one embodiment, the authenticated-based training curriculum provides context, resources, tools, tasks, and time period for users and admins. In one embodiment, the authenticated method training curriculum includes portfolio entrepreneurship. In one embodiment, the portfolio entrepreneurship incubates (i.e., set up), accelerates (i.e., scale-up), and operates (i.e., self-reliance). In one embodiment, the learning-based application platform enables users to learn business strategies, such as, law which includes government policies and regulation framework; Ethics and compliance culture which includes global mindset, oneness world-living unanimity and in diversity; Educational and training leadership which includes mindset, resilience communication, navigation, problem solving, accountability, people centric-outcome based curiosity innovation; Corporate social responsibility which includes social mission-charity-giving back to communities; Administration which includes hierarchy, managing partner, strategy partner, client partner, customer relationship manager, service relationship manager, and product relationship manager; Finance which includes corporate finance, investor relationships portfolio, possible potential and actual; Technology which includes business tools, assistive technology and hot line; Strategy which includes research and understand, customer and market, nosiness development, and build portfolios; Marketing customer relationship which includes customer relationship sales-hunter-new logos, and customer relationship-account management-farmer; Supply chain relationship which includes service provider relationship, SRM individual, SRM company, interviewer, reference and product provider relationship; Operations which includes smart contracts, creating invoices & follow ups and accounting (P&L); Logistics which includes background verification, on boarding, service provider, and product provider; Human resource management (HRM) which includes human capital & workforce, assistance, counselor and case management; and Mergers & acquisitions recognize & celebrate giving back to communities which includes social mission, social entrepreneurship and charity.

In one embodiment, the system further shows a sample landing page that includes Learn and earn modules. The learn and earn modules include simulation mode and entrepreneurship mode. In one embodiment, entrepreneurship mode functions in phase I and phase II. In one embodiment, the entrepreneurship mode provides access to real-world business experience for users by providing, a service portfolio, product portfolio, and service and consulting. In one embodiment, the social mission to bespoke communication business skills the learning platform provides portfolio entrepreneurship, law, ethics & compliance, culture & diversity, education & training, leadership, corporate social responsibility, administration, finance, technology, strategy-business development, marketing, customer relationship, supply chain relationship, operations, logistics, human resource management, mergers & acquisitions, recognize & celebrate, and giving back. Similarly, the entrepreneurship mode provides portfolio entrepreneurship, law, ethics & compliance, culture, education & training, leadership, corporate social responsibility, administration, finance, technology, strategy, marketing, customer relationship, supply chain relationship, operations, logistics, human resource management, mergers & acquisitions, recognize & celebrate, and giving back.

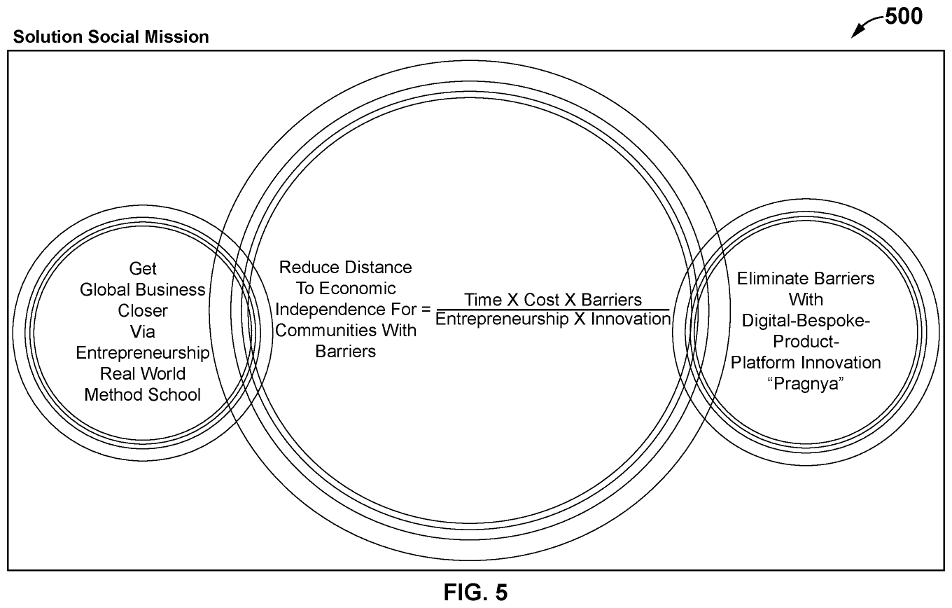

Referring to FIG. 5, a screenshot 500 of social mission, according to one embodiment of the present invention. In one embodiment, the social mission focuses on reducing the distance to economic independence for communities with the barrier. In one embodiment, to reduce the distance the global business is taken closer to the users via entrepreneurship real-world method school. In one embodiment, the entrepreneurship real-world method school eliminates barriers with digital, bespoke through the product innovation of learning-based platform PRAGNYA. In one embodiment, the reduced distance to economic independence for communities with the barrier is termed as time x cost x barriers/entrepreneurship x innovation.

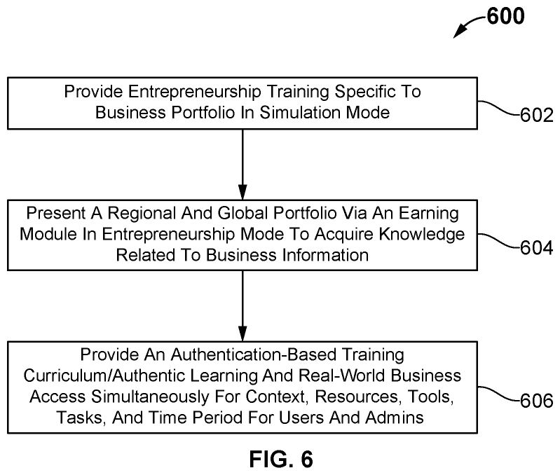

Referring to FIG. 6, a method flow 600 for providing artificial intelligence (AI) based entrepreneurship training, according to one embodiment of the present invention. In one embodiment, the method 600 includes a computer-implemented system executed in a network environment, comprising a computing device having at least one processor and a non-transitory memory unit coupled to the processor configured to store a set of instructions executable by the processor during each step of training, one or more databases in communication with the computing device via a communication network configured to store a plurality of data related to real-world business portfolio, and a user device in communication with the computing device via the communication network, having a user interface with a user profile associated with each user configured to establish interaction between the users during entrepreneurship training.

In one embodiment, the system provides a cross-continental business sustainability model through an AI-powered assistive system. In one embodiment, the AI-powered cloud assistive system includes a cloud-based based solution connected to one or more Li-Fi-based devices or sensors and connected to a learning-based application platform to assist users. In one embodiment, the AI-powered assistive system comprises the following steps. At step 602, the system provides entrepreneurship training specific to the business portfolio in simulation mode. At step 604, the system presents a regional and global portfolio via an earning module in entrepreneurship mode to acquire knowledge related to business information. At step 606, the system provides an authentication-based training curriculum/authentic learning and real-world business access simultaneously for context, resources, tools, tasks, and time period for users and admins.

Advantageously, the system of the present invention provides authentic learning and real-world business access simultaneously to users including sensory impaired users. It aids in gaining entrepreneur skills and stands out as independent business leaders who own and operate their respective business portfolios while accessing global business opportunities. The system or platform is affordable & accessible assistive technology to impaired users to learn job skills and knowledge and access global business opportunities relayed in PRAGNYA so that they can grow as entrepreneur leaders and live with economic independence, dignity, and self-esteem. Further, the system initiative is bound to social segments.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system executed in a network environment for providing artificial intelligence (AI) powered entrepreneurship training, comprising:
a computing device having at least one processor and a non-transitory memory unit coupled to the processor configured to store a set of instructions executable by the processor during each step of training;
one or more databases in communication with the computing device via a communication network configured to store a plurality of data related to real-world business portfolios, and
a user device in communication with the computing device via the communication network, having a user interface with a user profile associated with each user configured to establish interaction between the users during entrepreneurship training;
a learning-based application platform configured to learn entrepreneurship skills and strengthen communication, and
one or more Li-Fi based devices or sensors connected to an AI-powered cloud assistive system having a cloud-based based solution connected to the learning-based application platform to assist users, wherein the computing device is configured to,
reimage digital information using light waves or electric or electromagnetic or sound waves onto a tactile surface to assist visually blind, hearing/speech impaired to touch and perceive the information;
interchange transcription/translation modes as per user requirement, and
provide authentic learning and real-world business access simultaneously, thereby providing a cross-continental business sustainability model through AI powered assistive system.

2. The system of claim 1, wherein the AI-powered assistive system is configured to transcribe information from a format including visual, audio, textual, or tactile modes to another format.

3. The system of claim 1, wherein the AI-powered assistive system is configured to transcribe digital information onto a tactile pad to assist users including visually blind, hearing/speech impaired to touch and perceive the information by reimaging the digital information.

4. The system of claim 1, wherein the AI-powered assistive system is configured to translate relayed digital information from a language to the user's desired language, including sign languages.

5. The system of claim 1, wherein the AI-powered assistive system is configured to interchange modes between audio to video/sign language based on the user's requirement.

6. The system of claim 1, wherein the AI-powered assistive system provides runtime or offline mode of operations.

7. The system of claim 1, wherein the learning-based application platform provides communication facilities (bespoke) to assist users with barriers, including, physical, sensory, intellectual, behavioral, language, knowledge, academic, location, discrimination, gender, and the like.

8. The system of claim 1, perceives and responds to the business information provided in the learning-based application platform and learns job skills and knowledge related to the business environment provided in the learning-based application platform.

9. The system of claim 1, wherein the learning-based application platform enables users to learn business strategies, such as legal, supply chain research, human resource strategy, technology administration, marketing, finance, sales, operations, consumer relationships, accounts, mergers and acquisition, leadership, ethics and compliance, and entrepreneurship knowledge.

10. The system of claim 1, provides real-world portfolio entrepreneurship to access real-world business experience for users by providing, a service portfolio, product portfolio, and service and consulting.

11. A method for providing artificial intelligence (AI) based entrepreneurship training using a computer-implemented system executed in a network environment, comprising a computing device having at least one processor and a non-transitory memory unit coupled to the processor configured to store a set of instructions executable by the processor during each step of training, one or more databases in communication with the computing device via a communication network configured to store a plurality of data related to real-world business portfolio, and a user device in communication with the computing device via the communication network, having a user interface with a user profile associated with each user configured to establish interaction between the users during entrepreneurship training, wherein the method comprises the steps of:
providing a cross-continental business sustainability model through an AI-powered assistive system, wherein the AI-powered cloud assistive system includes a cloud-based based solution connected to one or more Li-Fi based devices or sensors and connected to a learning-based application platform to assist users, wherein the AI-powered assistive system comprises the steps of:
providing entrepreneurship training specific to the business portfolio in simulation mode;
presenting a regional and global portfolio via an earning module in entrepreneurship mode to acquire knowledge related to business information, and
providing an authentication-based training curriculum/authentic learning and real-world business access simultaneously for context, resources, tools, tasks, and time period for users and admins.

12. The method of claim 11, includes a reimagining of digital information using light waves or electric or electromagnetic, or sound waves onto a tactile surface to assist the visually blind, hearing/speech impaired to touch and perceive the information.

13. The method of claim 11, includes interchanging of transcription/translation modes as per user requirement.

14. The method of claim 11, wherein the AI-powered assistive system is configured to transcribe information from a format including visual, audio, textual, or tactile modes to another format.

15. The method of claim 11, wherein the AI-powered assistive system is configured to transcribe digital information onto a tactile pad to assist users including visually blind, hearing/speech impaired to touch and perceive the information by reimaging the digital information.

16. The method of claim 11, wherein the AI-powered assistive system is configured to translate relayed digital information from a language to the user's desired language, including sign languages.

17. The method of claim 11, wherein the learning-based application platform provides communication facilities (bespoke) to assist users with barriers, including, physical, sensory, intellectual, behavioral, language, knowledge, academic, location, discrimination, gender, and the like.

18. The method of claim 11, includes perceiving and responding to the business information provided in the learning-based application platform and learning job skills and knowledge related to the business environment provided in the learning-based application platform.

19. The method of claim 11, wherein the learning-based application platform enables users to learn business strategies, such as legal, supply chain research, human resource strategy, technology administration, marketing, finance, sales, operations, consumer relationships, accounts, mergers and acquisition, leadership, ethics and compliance, and entrepreneurship knowledge.

20. The method of claim 11, provides real-world portfolio entrepreneurship to access real-world business experience for users by providing, a service portfolio, product portfolio, and service and consulting.
